(19) United States
(12) Patent Application Publication
(10) Pub. No.: US 2019/0196693 A1
(43) Pub. Date: Jun. 27, 2019

(54) METHOD AND APPARATUS FOR DISPLAYING REMINDER MESSAGE

(71) Applicant: Alibaba Group Holding Limited, Grand Cayman (KY)

(72) Inventors: Boyu Yang, Zhejiang (CN); Ming Zhang, Zhejiang (CN); Jintao Lv, Zhejiang (CN); Dengxian Lai, Zhejiang (CN); Hailong Yao, Zhejiang (CN); Hongbo Zhu, Zhejiang (CN); Huachen Liu, Zhejiang (CN)

(73) Assignee: Alibaba Group Holding Limited

(21) Appl. No.: 16/293,312

(22) Filed: Mar. 5, 2019

Related U.S. Application Data
(63) Continuation of application No. PCT/CN2017/099452, filed on Aug. 29, 2017.

(30) Foreign Application Priority Data
Sep. 5, 2016 (CN) 201610801696.7

(51) Int. Cl. G06F 3/0481; G06F 9/54; G06F 3/0484

(52) U.S. Cl. CPC G06F 3/04817; H04L 51/04; G06F 3/0484; G06F 9/542

(57) ABSTRACT

A method including acquiring a received reminder message; identifying a pin-to-top reminder message or a common reminder message from the reminder message according to a display mode configured for the reminder message; and displaying the pin-to-top reminder message in a first display area in a reminder message display page, and displaying the common reminder message in a second display area in the reminder message display page, wherein the first display area and the second display area are respectively located at different positions in the reminder message display page. With the technical solution of the present disclosure, reminder messages may be mode-differentiated and partially displayed in a pin-to-top manner, thus preventing an important message from being obscured due to too many reminder messages, helping improve the reminding effect, and improving the communication efficiency.

### CROSS REFERENCE TO RELATED PATENT APPLICATIONS

This application claims priority to and is a continuation of PCT Patent Application No. PCT/CN2017/099452, filed on 29 Aug. 2017, which claims priority to Chinese Patent Application No. 201610801696.7 filed on 5 Sep. 2016 and entitled “METHOD AND APPARATUS FOR DISPLAYING REMINDER MESSAGE”, which are incorporated herein by reference in their entirety.

### TECHNICAL FIELD

The present disclosure relates to the field of communication technologies, and, more particularly, to methods and apparatuses for displaying reminder messages.

### BACKGROUND

In the related technology, reminder messages may be sent to a target user to remind the user to process related tasks or events in time. However, the reminder messages are easily abused, and as a result, the user often receives reminder messages for various events and scenarios, limiting the reminding effect of the reminder messages.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides a method and an apparatus for displaying reminder message, such that reminder messages are mode-differentiated and partially displayed in a pin-to-top manner, thus preventing an important message from being obscured due to too many reminder messages, helping improve the reminding effect, and improving the communication efficiency.

The present disclosure provides the following technical solutions.

According to a first aspect of the present disclosure, a method for displaying a reminder message is provided, including:

acquiring a received reminder message;

identifying a pin-to-top reminder message or a common reminder message from the reminder message according to a display mode configured for the reminder message; and

displaying the pin-to-top reminder message in a first display area in a reminder message display page, and displaying the common reminder message in a second display area in the reminder message display page, wherein the first display area and the second display area are respectively located at different positions in the reminder message display page.

The pin-to-top reminder message may also be referred to as prioritized reminder message.

According to a second aspect of the present disclosure, a method for displaying a reminder message is provided, including:

displaying a reminder message creation page which includes a mode switching identifier;

configuring a reminder message generated in the reminder message creation page to be in a corresponding display mode according to a trigger operation for the mode switching identifier; and

sending the reminder message to a target object, wherein when the display mode is a pin-to-top mode, wherein the reminder message is displayed in a first display area in a reminder message display page of the target object, while a reminder message in a common mode is displayed in a second display area in the reminder message display page, the second display area being different from the first display area.

According to a third aspect of the present disclosure, a method for displaying a reminder message is provided, including:

creating a reminder message;

configuring a creator of the reminder message as a target object when an instruction for sending the reminder message is detected and no target object is configured for the reminder message; and

receiving and displaying the reminder message.

According to a fourth aspect of the present disclosure, a method for displaying a reminder message is provided, including:

displaying a received reminder message, wherein a pin-to-top reminder message is displayed in a first display area in a reminder message display page, a common reminder message is displayed in a second display area in the reminder message display page, and the first display area and the second display area are respectively located at different positions in the reminder message display page; and

switching the common reminder message to a pin-to-top reminder message when the common reminder message is of a task type and a time interval to a deadline corresponding to the common reminder message is not greater than a preset time length.

According to a fifth aspect of the present disclosure, an apparatus for displaying reminder message is provided, including:

an acquiring unit configured to acquire a received reminder message;

an identifying unit configured to identify a pin-to-top reminder message or a common reminder message from the reminder message according to a display mode configured for the reminder message; and

a displaying unit configured to display the pin-to-top reminder message in a first display area in a reminder message display page and display the common reminder message in a second display area in the reminder message display page, wherein the first display area and the second display area are respectively located at different positions in the reminder message display page.

According to a sixth aspect of the present disclosure, an apparatus for displaying reminder message is provided, including:

a page displaying unit configured to display a reminder message creation page which includes a mode switching identifier;

a mode configuring unit configured to configure a reminder message generated in the reminder message creation page to be in a corresponding display mode according to a trigger operation for the mode switching identifier; and

a message sending unit configured to send the reminder message to a target object, wherein when the display mode is a pin-to-top mode, the reminder message is displayed in a first display area in a reminder message display page of the target object, while a reminder message in a common mode is displayed in a second display area in the reminder message display page, the second display area being different from the first display area.

According to a seventh aspect of the present disclosure, an apparatus for displaying reminder message is provided, including:

a creating unit configured to create a reminder message;

a configuring unit configured to configure a creator of the reminder message as a target object when an instruction for sending the reminder message is detected and no target object is configured for the reminder message; and

a displaying unit configured to receive and display the reminder message.

According to an eighth aspect of the present disclosure, an apparatus for displaying reminder message is provided, including:

a displaying unit configured to display a received reminder message, wherein a pin-to-top reminder message is displayed in a first display area in a reminder message display page, a common reminder message is displayed in a second display area in the reminder message display page, and the first display area and the second display area are respectively located at different positions in the reminder message display page; and

a switching unit configured to switch the common reminder message to a pin-to-top reminder message when the common reminder message is of a task type and a time interval to a deadline corresponding to the common reminder message is not greater than a preset time length.

As shown from the above technical solutions, the present disclosure configures an important reminder message to be in a pin-to-top mode by configuring different display modes for reminder messages, such that the corresponding pin-to-top reminder message is displayed at the top of a reminder message list page, thus enhancing the degree of attention paid to the pin-to-top reminder message by the user, helping improve the reminding effect of the pin-to-top reminder message relative to the common reminder message, preventing an important message from being obscured due to too many reminder messages, and helping improve the communication efficiency.

### BRIEF DESCRIPTION OF THE DRAWINGS

The accompanying drawings described herein are used to enable further understanding of the present disclosure and constitute a part of the present disclosure. Example embodiments of the present disclosure are used to explain the present disclosure, and are in no way intended to improperly limit the present disclosure. In the drawings:

FIG. 1 is a schematic diagram of a reminder message display page in the related technology.

FIG. 2 is a schematic diagram of a display effect of a reminder message display page in the related technology on an electronic device.

FIG. 3 is a flowchart of a method for displaying a reminder message based on a receiver side according to an example embodiment of the present disclosure.

FIG. 4 is a flowchart of a method for displaying a reminder message based on a sender side according to an example embodiment of the present disclosure.

FIG. 5 is a flowchart of a method for displaying a reminder message according to an example embodiment of the present disclosure.

FIG. 6 to FIG. 12 are schematic diagrams of relevant interfaces of reminder messages according to an example embodiment of the present disclosure.

FIG. 13 is a flowchart of another method for displaying a reminder message based on a sender side according to an example embodiment of the present disclosure.

FIG. 14 is a flowchart of another method for displaying a reminder message based on a receiver side according to an example embodiment of the present disclosure.

FIG. 15 is a schematic structural diagram of an electronic device based on a receiver side according to an example embodiment of the present disclosure.

FIG. 16 is a block diagram of an apparatus for displaying reminder message based on a receiver side according to an example embodiment of the present disclosure.

FIG. 17 is a schematic structural diagram of an electronic device based on a sender side according to an example embodiment of the present disclosure.

FIG. 18 is a block diagram of an apparatus for displaying reminder message based on a sender side according to an example embodiment of the present disclosure.

FIG. 19 is a schematic structural diagram of another electronic device based on a sender side according to an example embodiment of the present disclosure.

FIG. 20 is a block diagram of another apparatus for displaying reminder message based on a sender side according to an example embodiment of the present disclosure.

FIG. 21 is a schematic structural diagram of another electronic device based on a receiver side according to an example embodiment of the present disclosure.

FIG. 22 is a block diagram of another apparatus for displaying reminder message based on a receiver side according to an example embodiment of the present disclosure.

### DETAILED DESCRIPTION

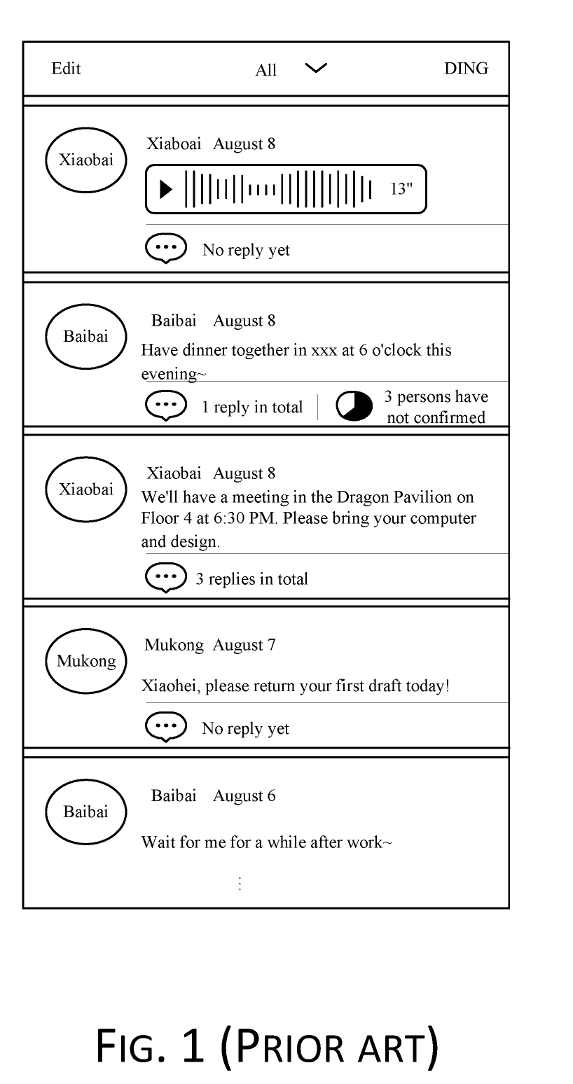

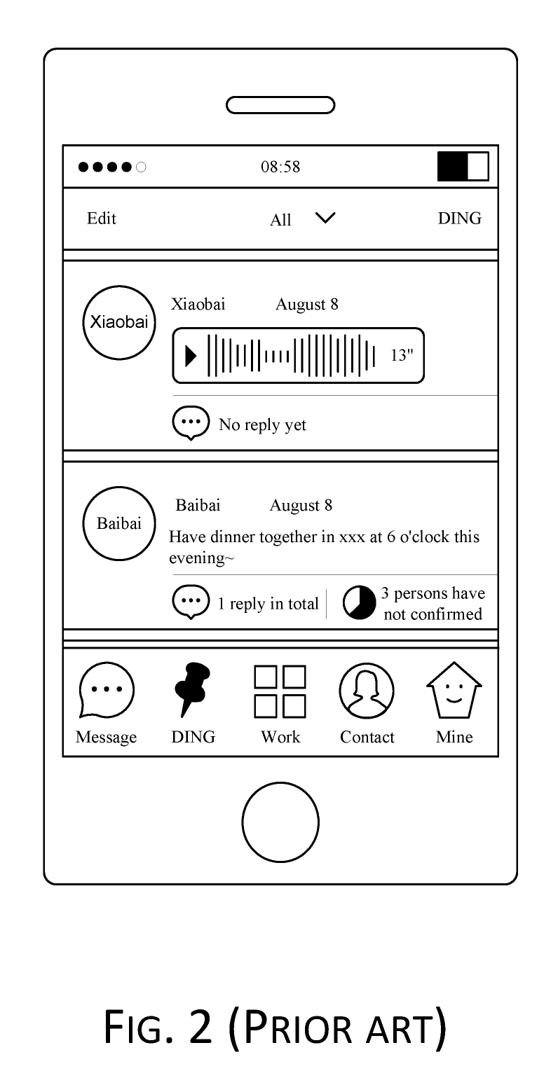

FIG. 1 is a schematic diagram of a reminder message display page in the related technology. As shown in FIG. 1, all reminder messages are arranged sequentially according to a receiving time sequence, and are displayed sequentially in a reminder message display page. However, as shown in FIG. 2, for example, only some of the reminder messages in the reminder message display page may be displayed at the same time due to the limited size of a screen of an electronic device where the reminder message display page is displayed, and a user may view more reminder messages only after manually flipping over the reminder message display page.

Then, when a work scenario is involved, for example, among reminder messages shown in FIG. 1, it is obvious that reminder messages related to work tasks or work progresses such as “We'll have a meeting in the Dragon Pavilion on Floor 4 at 6:30 PM. Please bring your computer and design” and “Xiaohei, please return your first draft today!” are more important than reminder messages such as “Have dinner together in xxx at 6 o′clock this evening” and “Wait for me for a while after work,” and therefore, the user expects that these important reminder messages are displayed preferentially, thus achieving enough reminding effects.

However, as shown in FIG. 2, reminder messages in the related technology are arranged merely according to a time sequence, and important reminder messages cannot be distinguished from unimportant reminder messages, so that important reminder messages are very likely to be obscured by more unimportant reminder messages, thus greatly reducing the reminding effect of the reminder messages.

Therefore, the present disclosure solves the above problems in the related technology by improving the method for displaying the reminder message. The following example embodiments are provided for further description of the present disclosure.

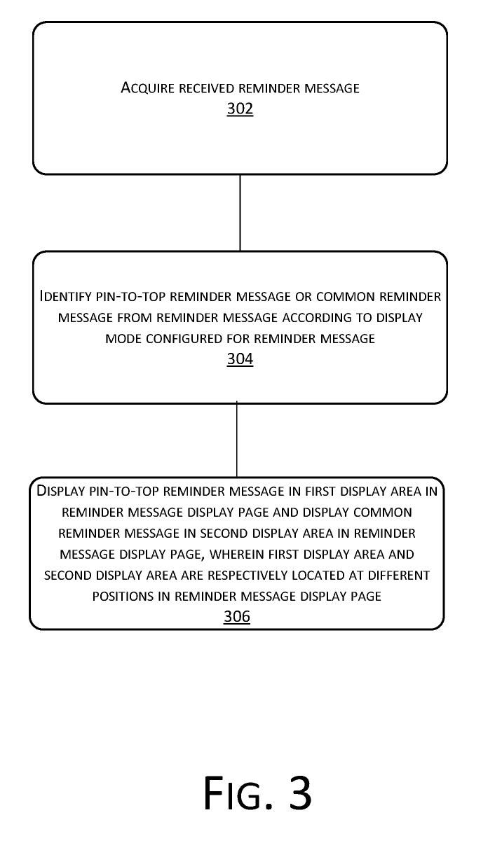

FIG. 3 is a flowchart of a method for displaying a reminder message based on a receiver side according to an example embodiment of the present disclosure. As shown in FIG. 3, the method is applied to an electronic device of a receiver, and may include the following steps:

Step 302: A received reminder message is acquired.

In this example embodiment, the reminder message may be sent with any communication application. For example, the communication application may be an instant messaging application such as an Enterprise Instant Messaging (EIM) application like DING Talk. Certainly, it is not limited in the present disclosure. The methods and devices, as described in the context of DING Talk, may be applied to any other communication application, device, and method.

In this example embodiment, the reminder message may be sent by a user to himself/herself, that is, a sender of the reminder message may be the same as the receiver of the reminder message. Therefore, when the user creates a reminder message, if an instruction of the user for sending the reminder message is detected and no receiver is configured for the reminder message, the electronic device may use the local user as the receiver of the reminder message automatically, and the user does not need to configure a target object (i.e., the receiver) of the reminder message manually, thus helping improve the operating efficiency of the user.

Certainly, the receiver may be different from the sender of the reminder message. That is, transmission of the reminder message is implemented between users. This is not limited in the present disclosure.

Step 304: A pin-to-top reminder message or a common reminder message is identified from the reminder message according to a display mode configured for the reminder message.

In an example embodiment, the display mode may be configured by the sender of the reminder message. For example, a mode switching identifier may be displayed on a reminder message creation page on the electronic device used by the sender, and the reminder message may be configured to be a pin-to-top mode or a common reminder mode according to the sender's trigger for the mode switching identifier, so as to obtain a pin-to-top reminder message or a common reminder message.

In another example embodiment, the display mode may be configured by the receiver of the reminder message. For example, when a reminder message is received, a reception prompt window of the reminder message may be displayed, and configuration options respectively corresponding to a pin-to-top mode and a common mode are provided in the reception prompt window. Therefore, according to the receiver's trigger for the configuration option, for example, it may be determined that the reminder message is configured as a pin-to-top reminder message when the pin-to-top mode is triggered, and it may be determined that the reminder message is configured as a common reminder message when the common mode is triggered.

Step 306: The pin-to-top reminder message is displayed in a first display area in a reminder message display page, and the common reminder message is displayed in a second display area in the reminder message display page, wherein the first display area and the second display area are respectively located at different positions in the reminder message display page.

In this example embodiment, when the reminder message display page is in a list form (i.e., a reminder message list page), all reminder messages are arranged sequentially from top to bottom, the first display area may be located at the top of the list, and the second display area may be located below the first display area, such that the pin-to-top reminder message is displayed in a “pin-to-top” manner.

Certainly, the reminder message display page may also be in another form. For example, when the reminder message display page arranges reminder messages sequentially from left to right, the first display area may be on the leftmost side of the reminder message display page, and the second display area may be located on the right of the first display area. Certainly, this is not limited in the present disclosure.

In fact, the reminder message display page generally has a corresponding start position and an end position regardless of the used display form, so that the reminder messages are arranged sequentially between the start position and the end position. Therefore, the first display area may be located at the start position, and the second display area is relatively away from the start position. As a result, when the user starts to browse the reminder message display page from the start position, the user may always view the pin-to-top reminder message first, thus implementing the “pin-to-top” display effect for the pin-to-top reminder message.

In this example embodiment, when there is a plurality of pin-to-top reminder messages, the plurality of pin-to-top reminder messages displayed at the top may be arranged according to a corresponding receiving time sequence.

In this example embodiment, details of the pin-to-top reminder message may be displayed to allow the user to quickly know the content of the pin-to-top reminder message without further clicking and entering the detail page, being conducive to improving the viewing efficiency. Thumbnails of the common reminder message may be displayed to reduce the display area of each common reminder message, so as to display more common reminder messages on a page of the same specification, such that the user may conveniently view more common reminder messages at the same time, thus helping improve the viewing efficiency.

When the reminder message is of a task type, that is, the reminder message has a deadline and the receiver needs to return a task performance to the sender before the deadline, the pin-to-top reminder message may display corresponding task information for the user to directly browse and view conveniently. Task information of the common reminder messages may be hidden such that more common reminder messages may be displayed. Certainly, if a common reminder message is triggered, task information of the common reminder message may be displayed in a corresponding detail page for the user to browse and view conveniently.

In this example embodiment, a first identifier corresponding to the pin-to-top mode may be displayed in a display range of the pin-to-top reminder message; or a second identifier corresponding to the common mode may be displayed in a display range of the common reminder message, wherein the first identifier is different from the second identifier. Then, when the user views the reminder message, the user may obtain a strong visual sense from the first identifier and the second identifier, so as to identify the type of the reminder message as the pin-to-top reminder message or the common reminder message more conveniently.

The first identifier may include a pushpin icon in a pinned state, and the second identifier may include a pushpin icon in a non-pinned state. In this case, for the user, the pin-to-top reminder message looks like a corresponding reminder message “pinned” in the first display area with the “pushpin,” and the common reminder message looks like a corresponding reminder message “released” to the second display area after the “pushpin” is pulled out. As such, the “pin to top” and “not pin to top” may provide a more intuitive and lively visual effect and use experience.

Further, a corresponding pin-to-top reminder message may be switched to a common reminder message according to a received trigger operation for the first identifier; and a corresponding common reminder message may be switched to a pin-to-top reminder message according to a received trigger operation for the second identifier. Therefore, the user may manually switch the type of the reminder message to meet reminding requirements in different conditions.

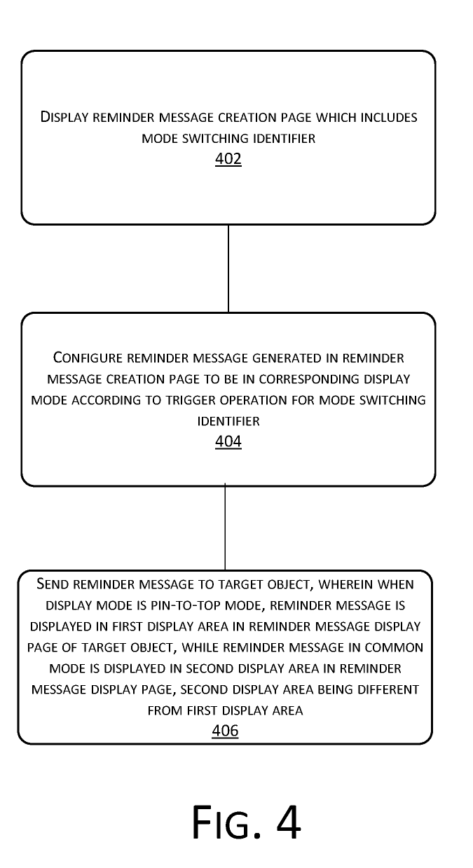

Correspondingly, FIG. 4 is a flowchart of a method for displaying a reminder message based on a sender side according to an example embodiment of the present disclosure. As shown in FIG. 4, the method is applied to an electronic device of a sender, and may include the following steps:

Step 402: A reminder message creation page which includes a mode switching identifier is displayed.

Step 404: A reminder message generated in the reminder message creation page is configured to be in a corresponding display mode according to a trigger operation for the mode switching identifier.

In this example embodiment, a user as the sender may actively configure a display mode of the reminder message by means of the trigger operation for the mode switching identifier, to configure the reminder message as a pin-to-top reminder message, a common reminder message, or the like, thus achieving reminding requirements having different strengths. For example, a relatively unimportant event may be configured as a common reminder message, and a relatively important event may be configured as a pin-to-top reminder message.

Step 406: The reminder message is sent to a target object, wherein when the display mode is a pin-to-top mode, the reminder message is displayed in a first display area in a reminder message display page of the target object, while a reminder message in a common mode is displayed in a second display area in the reminder message display page, the second display area being different from the first display area.

In this example embodiment, when the reminder message creation page includes a task start identifier, the reminder message may be configured as a task type according to a trigger operation for the task start identifier. Then, a pre-hidden task configuration option for the reminder message may be displayed near the task start identifier, and task information of the reminder message may be configured according to a received configuration operation for the task configuration option. By pre-hiding and temporarily displaying the task configuration option, page display information may be reduced and the reminder message creation page may be simplified when the reminder message is of a non-task type, avoiding interference to the creating process of the non-task type reminder message, such that the task configuration option and the task type are associated more closely. The user may configure at least one of the following task information: a deadline, a task reminding moment before the deadline, and the like.

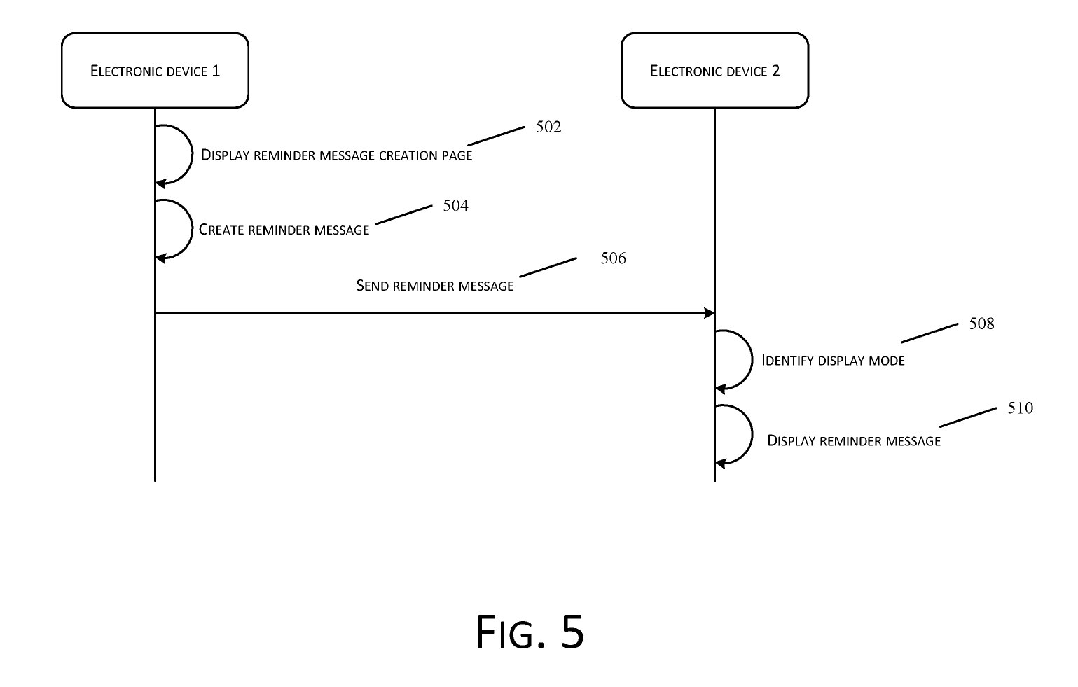

For ease of understanding, the technical solution of the present disclosure is illustrated in detail below with reference to FIG. 5 by taking message reminding of the EIM application DING Talk in an enterprise scenario as an example. FIG. 5 is a flowchart of display of a reminder message according to an example embodiment of the present disclosure. As shown in FIG. 5, the method is applied to electronic devices used by a sender and a receiver of the reminder message. These electronic devices have DING Talk client terminals installed therein, and specifically, the DING Talk client terminals achieve transmission and display functions of reminder messages of the present disclosure during operation. The method may include the following steps:

Step 502: An electronic device 1 used by the sender displays a reminder message creation page.

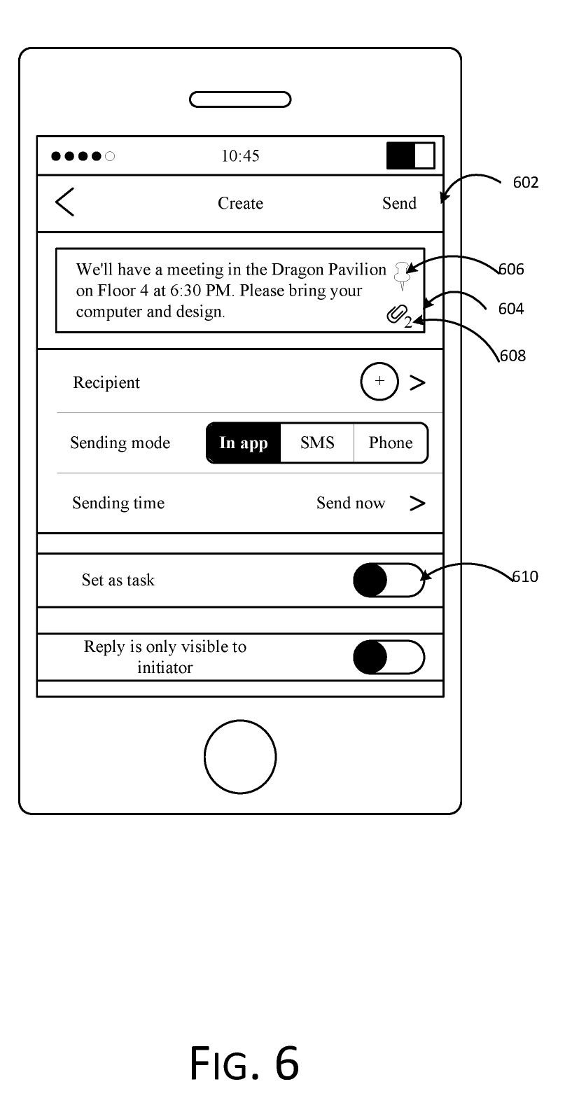

In this example embodiment, DING Talk is used as an example. The DING Talk may provide a reminder message creation page 602 as shown in FIG. 6 for the sender to create a reminder message. For example, the reminder message may be a DING message. As shown in FIG. 6, the reminder message creation page 602 includes a plurality of parts: an input field 604 located on the upper part of the page, in which “We'll have a meeting in the Dragon Pavilion on Floor 4 at 6:30 PM. Please bring your computer and design” is displayed in the input field; a mode switching identifier 606 (pushpin-shaped) located at the upper right corner in the input field; an attachment icon 608 located at the lower right corner; and a numeral “2” displayed beside the attachment icon and indicating that the user selects two attachments for the reminder message. Certainly, the user may further select one or more attachments or does not select any attachment, wherein the attachment may include a picture, a video, a document file, and the like. Meanwhile, the page further includes options such as “Recipient,” “Sending mode,” “Sending time,” “Set as task,” and “Reply is only visible to initiator,” for the user to make selection and configuration.

Step 504: The electronic device 1 creates a reminder message according to the detected operation of the sender.

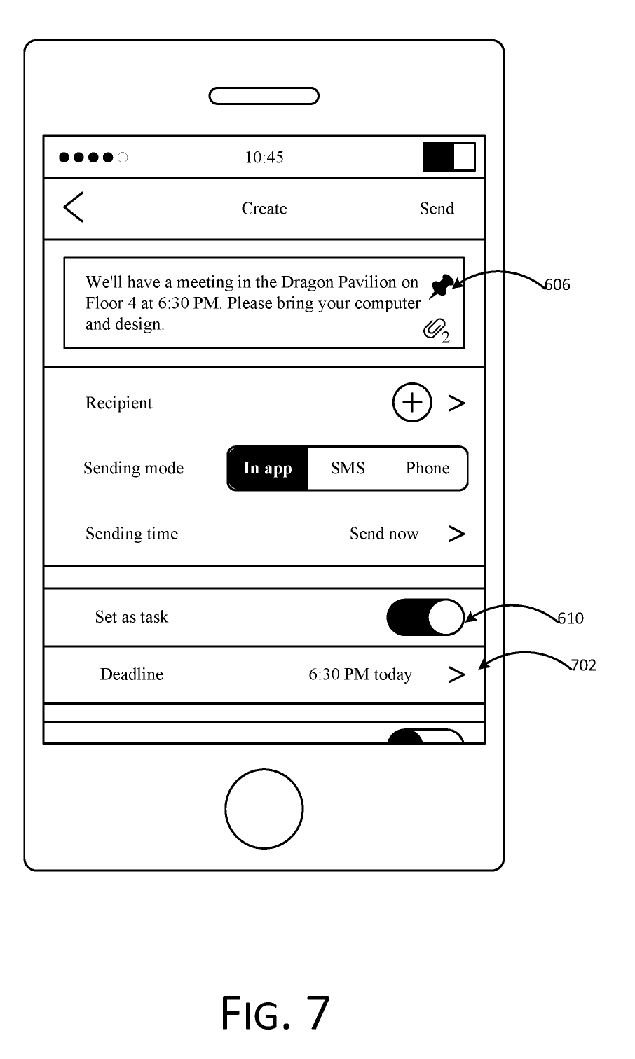

In this example embodiment, the mode switching identifier shown in FIG. 6 may be used by the sender to configure a display mode of the reminder message. For example, when the mode switching identifier 606 is in the state shown in FIG. 6, it indicates that the reminder message is in a common mode, that is, the reminder message is a common reminder message. When the sender triggers the mode switching identifier in a manner such as clicking, the mode switching identifier 606 may be changed to the state shown in FIG. 7, indicating that the reminder message is in a pin-to-top mode, that is, the reminder message is a pin-to-top reminder message.

In this example embodiment, the sender may further configure the reminder message as a task type, so as to distinguish it from a reminder message of a normal type. For the reminder message of the task type, after receiving the corresponding reminder message, the receiver needs to return a task performance of the reminder message to the sender. The sender may further configure a corresponding task deadline for the reminder message, such that the receiver needs to complete task processing before the deadline.

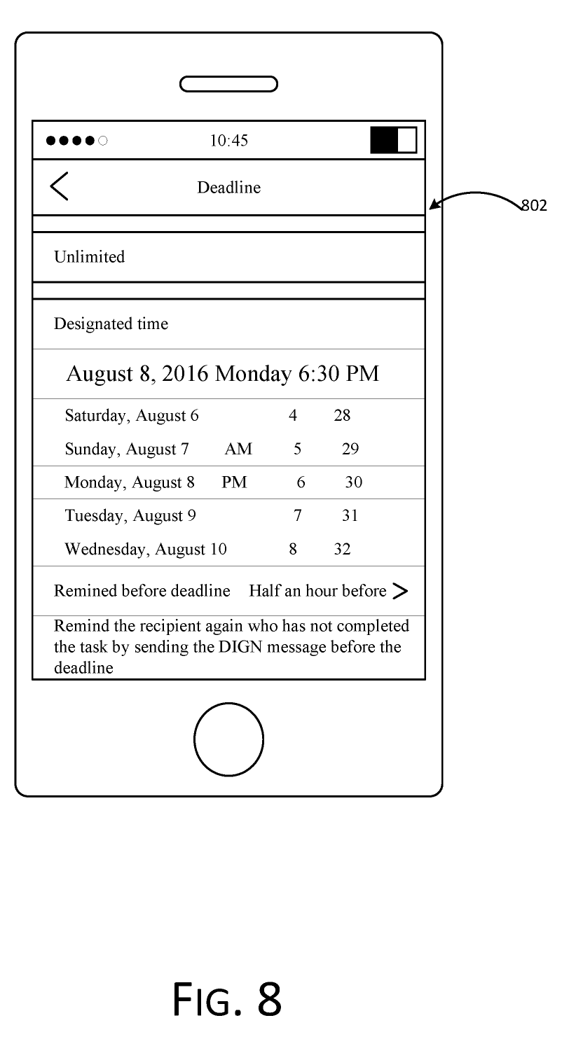

A task start identifier may be displayed in the reminder message creation page, and the reminder message may be configured as a task type when a trigger operation for the task start identifier is detected. Further, a pre-hidden task configuration option for the reminder message may be displayed near the task start identifier after the reminder message is configured as the task type. For example, as shown in FIG. 6, a virtual button 610 on the right of the “Set as task” option is used as the task start identifier. When the virtual button 610 is slid to the right side, it is determined that the trigger operation is detected, and therefore, the state as shown in FIG. 7 may be switched to, indicating that the corresponding reminder message is configured as the task type. The originally hidden task configuration option 702 may be displayed under the virtual button 610 to configure task information of the reminder message. For example, the task configuration option 702 in FIG. 7 is “deadline,” for configuring the deadline of the reminder message. For example, by conducting intelligent semantic analysis on the content “6:30 PM” in the reminder message input by the user, the deadline may be automatically configured as “6:30 PM today” as shown in FIG. 7. Certainly, the user may further invoke a deadline configuration page 802 as shown in FIG. 8 by triggering the “deadline,” so as to configure the deadline of the reminder message of the task type as “Unlimited (i.e., the deadline is infinite)” or a certain “Designated time (e.g., ‘6:30 PM, Monday, August 8’).” Meanwhile, a pre-deadline reminding time (i.e., a task reminding moment before the deadline) related to the deadline may further be set, for example, to “half an hour before,” and then the DING Talk server will send a reminder message (e.g., a DING message) half an hour before the deadline to remind the receiver (i.e., the recipient) again who has not finished the task.

Step 506: The sender sends a reminder message through the electronic device 1, and the receiver receives the reminder message through an electronic device 2.

In this example embodiment, the sending side and the receiving side of the reminder message are distinguished by using the sender, the receiver, the electronic device 1, the electronic device 2, and the like in the present disclosure; however:

In an example embodiment, the sender and the receiver are different users, and the two achieve sending and receiving of the reminder message respectively by using the electronic device 1 and the electronic device 2 that are different from each other, which will not be repeated here.

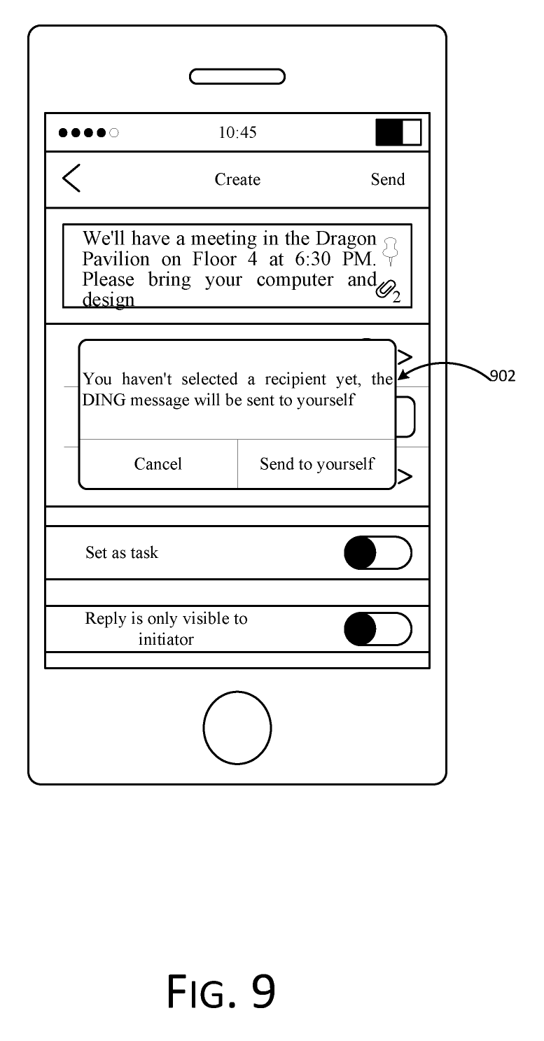

In another example embodiment, the sender and the receiver may be the same user, and then the electronic device 1 and the electronic device 2 may actually be the same electronic device. For example, as shown in FIG. 6 (or FIG. 7), assuming that it is detected that the user triggers a “Send” button on the upper right corner of the reminder message creation page, then it is determined that an instruction for sending the reminder message has been received. However, the sender does not configure a “recipient” (i.e., a receiver or a target object), so the sender may be configured as the “recipient,” thus sending the reminder message to the sender himself/herself. This is equivalent to creating a reminder event or a task event. Certainly, to avoid maloperations of the user, when the instruction for sending the reminder message is received and no “recipient” is configured for the reminder message, a pop-up operation window 902 in FIG. 9 may be displayed first. The pop-up operation window 902 includes “Cancel” and “Send to yourself” options, and a prompt text such as “You haven't selected a recipient, the DING message will be sent to yourself” may further be displayed. When the user selects “Cancel,” the reminder message creation page shown in FIG. 6 (or FIG. 7) may be returned to, and when the user selects “Send to yourself,” the sender may be configured as the “recipient,” thus sending the reminder message to the sender himself/herself

Step 508: The electronic device 2 identifies the display mode of the reminder message.

Step 510: The electronic device 2 displays the reminder message in the reminder message display page.

In this example embodiment, when the sender configures the reminder message to be in the pin-to-top mode by using the mode switching identifier as shown in FIG. 6 or FIG. 7, the electronic device 1 may add a mode label corresponding to the pin-to-top mode into the reminder message, such that after receiving the reminder message, the electronic device 2 may identify according to the mode label whether the reminder message is a pin-to-top reminder message. By adding a mode label corresponding to the common mode into the reminder message or not adding any mode label, the common reminder message may be distinguished from the pin-to-top mode. Certainly, in other cases, a mode label may be added only for the reminder message in the common mode, no mode label is added in the pin-to-top mode, or the like, as long as different mode types may be differentiated, which is not limited in the present disclosure.

In this example embodiment, the reminder messages are classified into pin-to-top reminder messages and common reminder messages. When all the reminder messages are displayed in the reminder message list page, the pin-to-top reminder messages are displayed in a pin-to-top manner. That is, the pin-to-top reminder messages are always displayed at the top of the reminder message list page and located above all the common reminder message.

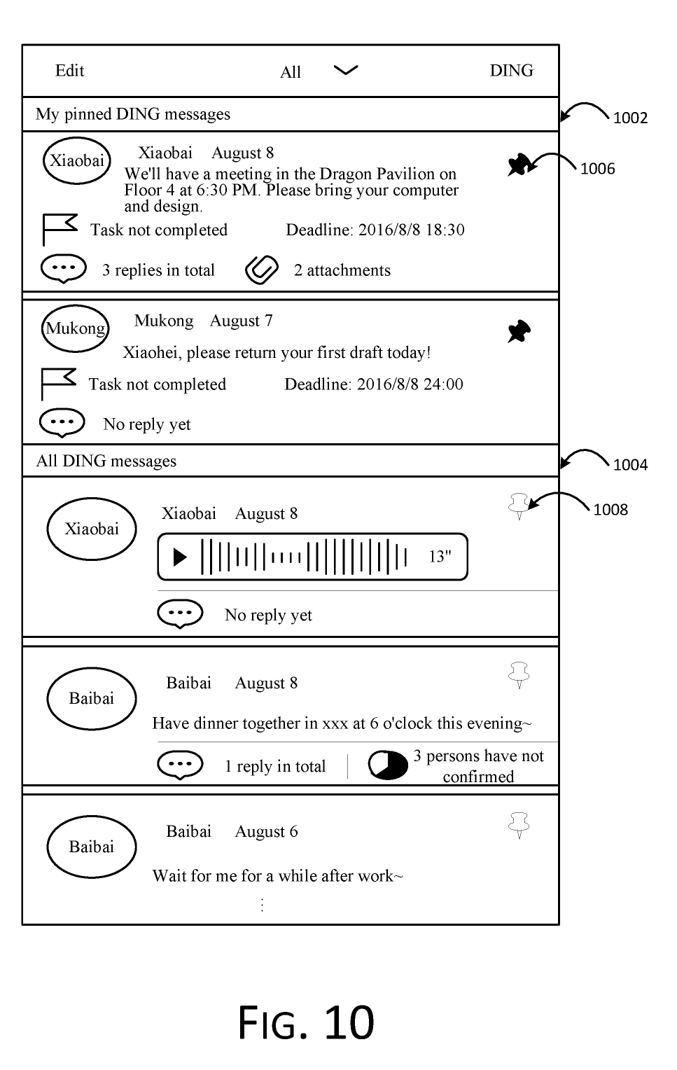

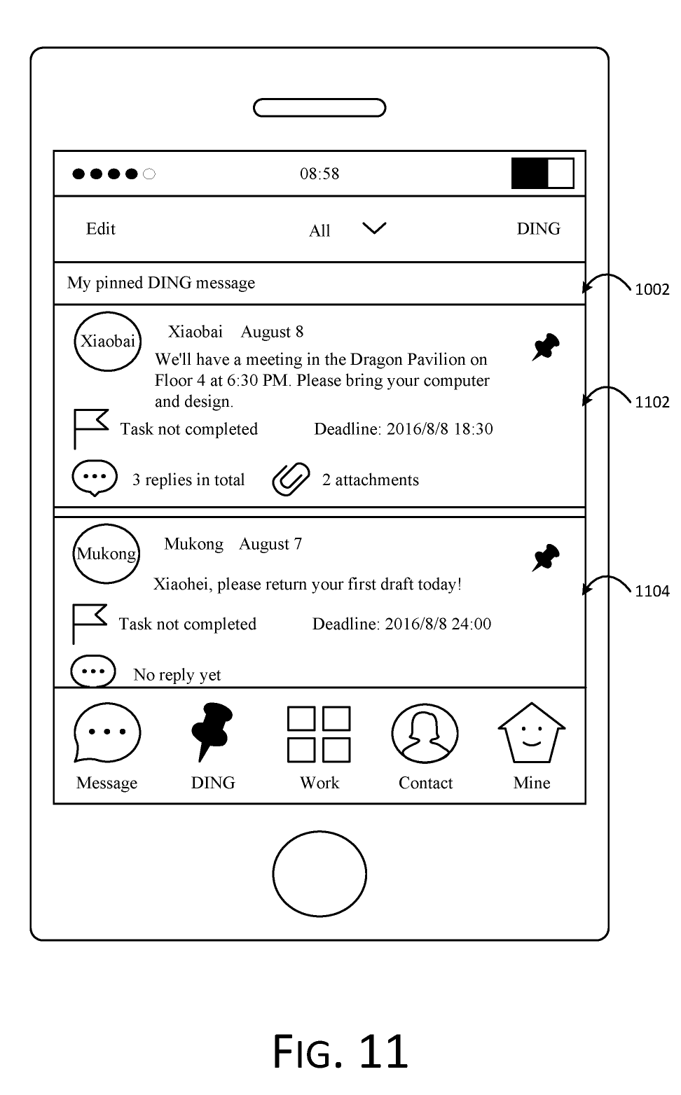

For example, FIG. 10 is a schematic diagram of a reminder message display page according to an example embodiment. The reminder message display page shown in FIG. 10 includes two areas: a “My pinned DING messages” area 1002 at the top, which is always located at the top of the reminder message display page to display pin-to-top reminder messages at the top; and an “All DING messages” area 1004 located below the “My pinned DING messages” area 1002. The “All DING messages” area 1004 is always located below the “My pinned DING messages” area 1002 to display common reminder messages. Further, it may be seen with reference to FIG. 11 that an important reminder message is configured as a pin-to-top reminder message, such that the user may always view the pin-to-top reminder message displayed at the top first even if a screen may only display some reminder messages due to a limited size of the electronic device. Even if some pin-to-top reminder messages cannot be displayed on the screen of the electronic device directly, for example, FIG. 11 only displays two pin-to-top reminder messages 1102 and 1104 at the top while there may be a total of three pin-to-top reminder messages actually, and the user only needs to slightly scroll the reminder message display page to view the third pin-to-top reminder message. It is unnecessary to scroll the reminder message display page by a large margin to look for the reminder message, so that the user may view and process the reminder message more quickly and conveniently, thus helping improve the user's efficiency of processing the reminder message.

As shown in FIG. 10, an identifier corresponding to a display mode of a reminder message may be displayed in a display range of the reminder message. For example, a first identifier 1006 corresponding to the pin-to-top mode may be displayed in a display range of a pin-to-top reminder message, while a second identifier 1008 corresponding to the common mode may be displayed in a display range of a common reminder message.

The first identifier 1006 should be different from the second identifier 1008, so that different types of reminder messages may be distinguished quickly and effectively. For example, the first identifier 1006 may include a pushpin icon in a pinned state, and the second identifier 1008 may include a pushpin icon in a non-pinned state. In this case, for the user, the pin-to-top reminder message looks like a corresponding reminder message “pinned” in the first display area with the “pushpin,” and the common reminder message looks like a corresponding reminder message “released” to the second display area after the “pushpin” is pulled out. As such, the “pin to top” and “not pin to top” may provide a more intuitive and lively visual effect and use experience.

As shown in FIG. 10 and FIG. 11, a plurality of pin-to-top reminder messages may coexist. Then, the plurality of pin-to-top reminder messages may be arranged according to their corresponding receiving time sequence. Certainly, the pin-to-top reminder messages may also be arranged using other methods. For example, when the pin-to-top reminder messages are of a task type, they may be arranged according to a corresponding deadline order, which is not limited in the present disclosure.

In this example embodiment, to help the user view the pin-to-top reminder message more conveniently, details of the pin-to-top reminder message may be displayed in the reminder message display page, while thumbnails of the common reminder message may be displayed. For example, when the reminder message is of a task type, as shown in FIG. 10, in the case of a pin-to-top reminder message, task information of the pin-to-top reminder message may be displayed directly. For example, task performance (such as “task not completed”), a task deadline (such as deadline: 2016/8/8 18:30) and the like may be displayed, such that the user may directly view related information of the pin-to-top reminder message without performing other operations. In the case of a common reminder message, task information of the common reminder message may be hidden. In this case, each common reminder message occupies a smaller display area, such that more common reminder messages are displayed at the same time on the screen of the electronic device. As such, when scrolling the reminder message display page by a large margin, the user may view concerned common reminder messages more conveniently and quickly, thus improving the user's efficiency of viewing and processing the common reminder messages. Certainly, the user may trigger a common reminder message, for example, click the common reminder message; then a corresponding detail page may be displayed, and task information of the common reminder message is displayed in the detail page.

It should be noted that:

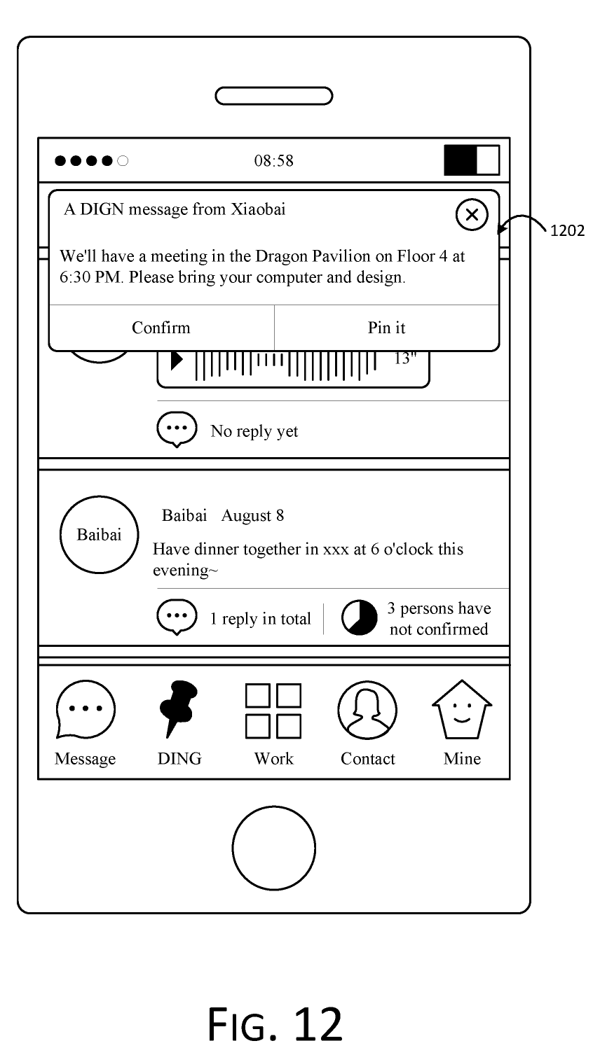

1. In addition to the manner of configuring the reminder message using the mode switching identifier as shown in FIG. 7, the display mode of the reminder message may further be configured by the receiver. For example, as shown in FIG. 12, when a reminder message is received, a message box 1202 as shown at the top of FIG. 12 may be displayed, and content (all or part of the content) of the reminder message as well as operation options for the reminder message, such as “OK” and “Pin it,” are displayed in the message box. When it is detected that the operation option “Pin it” is triggered, it may be determined that the reminder message currently received by the user this afternoon is configured to be in a pin-to-top mode, so as to be displayed in the “My pinned DING messages” area 1002 shown in FIG. 11.

Certainly, the electronic device 2 of the receiver may first detect whether the received reminder message has been configured to be in a pin-to-top mode by the sender. When the reminder message has been configured to be in a pin-to-top mode by the sender, the reminder message may be displayed in a pin-to-top manner, and the receiver does not need to configure it again. When the reminder message is in a common mode, the display mode of the reminder message is configured by the receiver through the message box 1202 shown in FIG. 12.

2. User A, User B, and User C are taken as examples. Assuming that User A is a sender, and User B and User C are receivers, after receiving a reminder message sent by User A, User B and User C may both reply to the reminder message. For example, in FIG. 11, “3 replies in total” is shown in FIG. 11 corresponding to the reminder message “We'll have a meeting in the Dragon Pavilion on Floor 4 at 6:30 PM. Please bring your computer and design,” indicating that there are three reply messages for the reminder message.

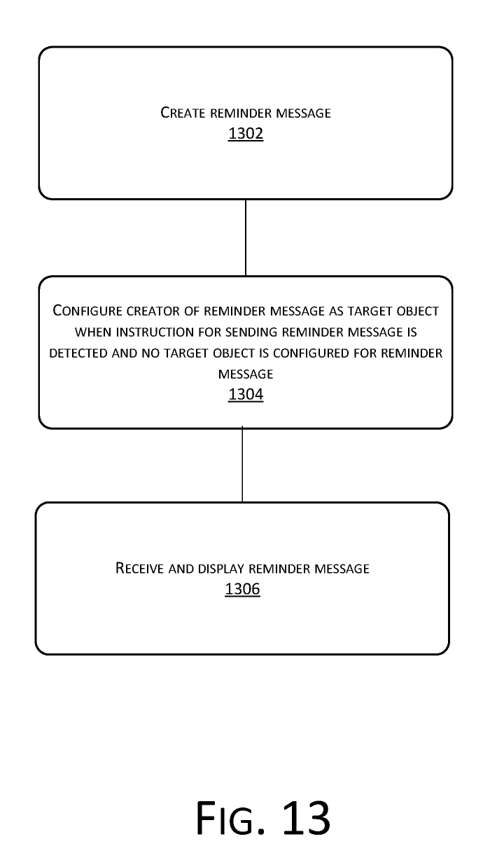

For example, for the scenario as shown in FIG. 9, FIG. 13 shows a method for displaying a reminder message according to an example embodiment of the present disclosure. As shown in FIG. 13, the method is applied to an electronic device, and may include the following steps:

Step 1302: A reminder message is created.

Step 1304: A creator of the reminder message is configured as a target object when an instruction for sending the reminder message is detected and no target object is configured for the reminder message.

Step 1306: The reminder message is received and displayed.

In this example embodiment, by detecting configuration of a target object of the reminder message and actively configuring the creator to the target object when no object target is configured, on one hand, the creator may add a reminder message for himself/herself to implement the function of reminding a relevant event, task, and the like; and on the other hand, the creator does not need to manually configure the target object as himself/herself, thus helping simplify user operations and improving the efficiency of sending the reminder message.

Further, the reminder message may be determined as a pin-to-top reminder message or a common reminder message according to a display mode configured for the reminder message. Then the pin-to-top reminder message is displayed in a first display area in a reminder message display page, and the common reminder message is displayed in a second display area in the reminder message display page. The first display area and the second display area are respectively located at different positions in the reminder message display page. Reference may be made to the example embodiment shown in FIG. 3 for the process of displaying the reminder message, which will not be repeated here.

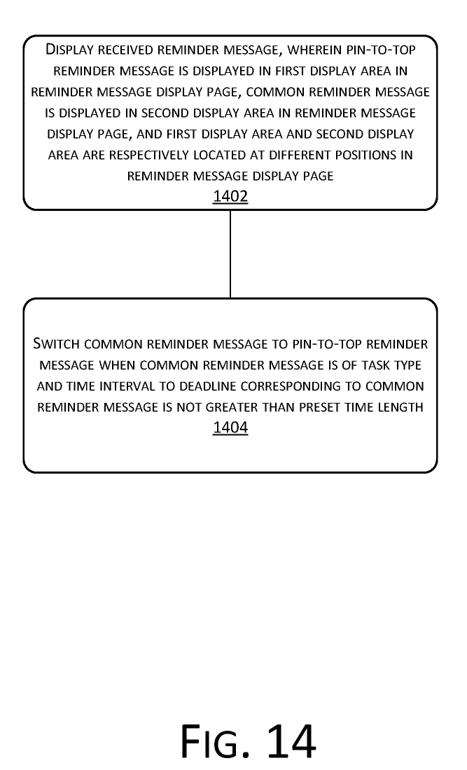

In the technical solution of the present disclosure, for example, in the reminder message display page shown in FIG. 10, when an identifier corresponding to the display mode of the reminder message is displayed in the display range of the reminder message, the user may trigger the relevant identifier to switch the corresponding reminder message between a pin-to-top reminder message and a common reminder message. Further, automatic type switching of a reminder message may be implemented in the following manner, which is illustrated below with reference to FIG. 14. FIG. 14 shows a method for displaying a reminder message according to an example embodiment of the present disclosure. As shown in FIG. 14, the method is applied to an electronic device, and may include the following steps:

Step 1402: A received reminder message is displayed, wherein a pin-to-top reminder message is displayed in a first display area in a reminder message display page, a common reminder message is displayed in a second display area in the reminder message display page, and the first display area and the second display area are respectively located at different positions in the reminder message display page.

Step 1404: The common reminder message is switched to a pin-to-top reminder message when the common reminder message is of a task type and a time interval to a deadline corresponding to the common reminder message is not greater than a preset time length.

In this example embodiment, the creator may configure a corresponding reminder message as a task type by triggering a “Set as task” option as shown in FIG. 7. The task-type reminder message has the following characteristics: the reminder message has a corresponding deadline (which may be configured by the creator through a “Deadline” option as shown in FIG. 7), and the receiver of the reminder message needs to return corresponding task processing information to the creator, and the like.

Then, by monitoring the deadline of the task-type common reminder message and by automatically switching the common reminder message to a pin-to-top reminder message when a time interval to the deadline is not greater than a preset time length, e.g., 1 day (or another preset time length) before the deadline, the user may view the task-type reminder message more conveniently and process the task-type reminder message in time, thus avoiding omission.

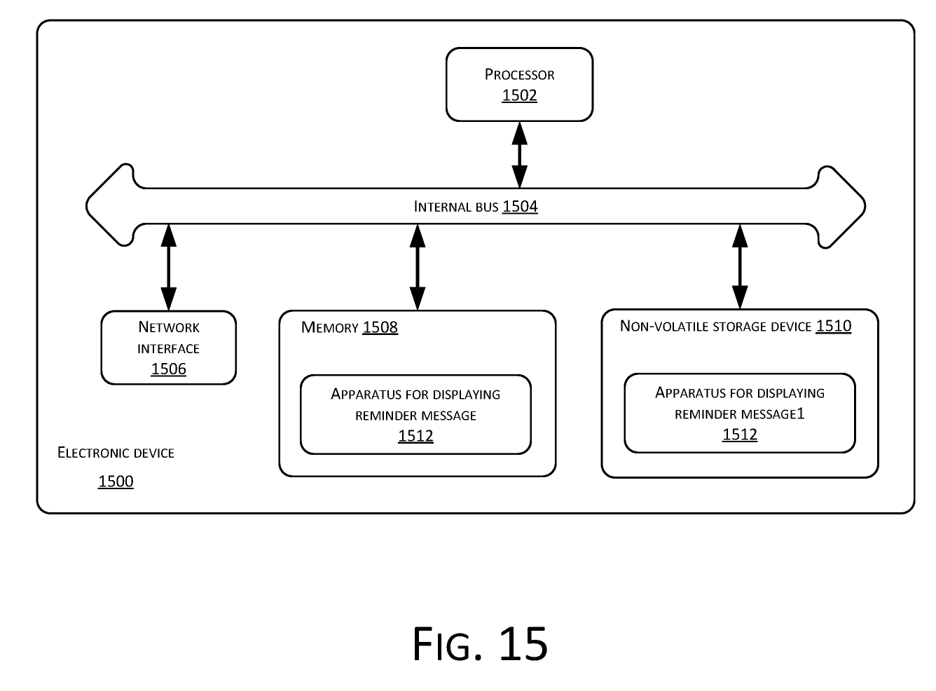

FIG. 15 is a schematic structural diagram of an electronic device 1500 according to an example embodiment of the present disclosure. Referring to FIG. 15, on the hardware level, the electronic device 1500 includes a processor 1502, an internal bus 1504, a network interface 1506, a memory 1508 and a non-volatile storage device 1510, and certainly may further include other hardware required by services. The processor 1502 reads a corresponding computer program from the non-volatile storage device 1510 to the memory 1502 and then runs the computer program to form an apparatus for displaying reminder message 1512 on the logic level. Certainly, apart from the software implementation, the present disclosure does not exclude other implementations such as logic devices or a combination of software and hardware. In other words, the following processing procedure is executed by, but not limited to, various logic units, and may also be executed by hardware or logic devices.

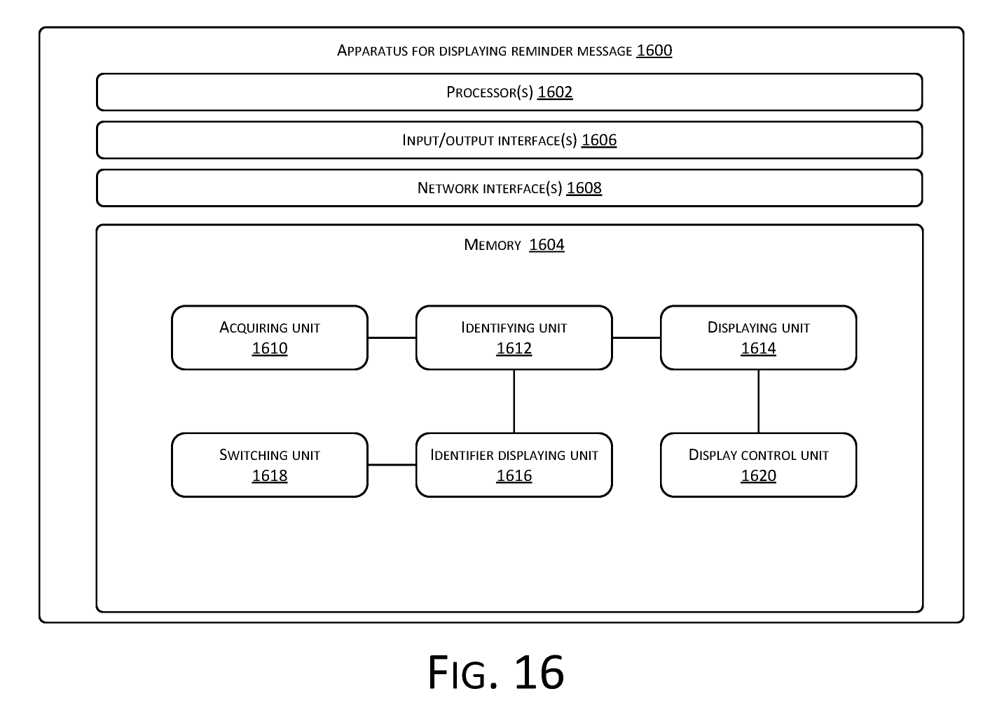

Referring to FIG. 16, an apparatus for displaying reminder message 1600 may include one or more processor(s) 1602 or data processing unit(s) and memory 1604. The apparatus for displaying reminder message 1600 may further include one or more input/output interface(s) 1606 and one or more network interface(s) 1608. The memory 1604 is an example of computer readable medium or media.

The memory 1604 may store therein a plurality of modules or units including an acquiring unit 1610, an identifying unit 1612, and a displaying unit 1614.

The acquiring unit 1610 is configured to acquire a received reminder message.

The identifying unit 1612 is configured to identify a pin-to-top reminder message or a common reminder message from the reminder message according to a display mode configured for the reminder message.

The displaying unit 1614 is configured to display the pin-to-top reminder message in a first display area in a reminder message display page and display the common reminder message in a second display area in the reminder message display page, wherein the first display area and the second display area are respectively located at different positions in the reminder message display page.

Optionally, the apparatus for displaying reminder message 1600 may further includes the following module or unit stored in the memory 1604:

an identifier displaying unit 1616 configured to display a first identifier corresponding to the pin-to-top mode in a display range of the pin-to-top reminder message; and display a second identifier corresponding to the common mode in a display range of the common reminder message,

wherein the first identifier is different from the second identifier.

Optionally, the first identifier includes a pushpin icon in a pinned state; and the second identifier includes a pushpin icon in a non-pinned state.

Optionally, the apparatus for displaying reminder message 1600 may further includes the following module or unit stored in the memory 1604:

a switching unit 1618 configured to switch a corresponding pin-to-top reminder message to a common reminder message according to a received trigger operation for the first identifier; and switch a corresponding common reminder message to a pin-to-top reminder message according to a received trigger operation for the second identifier.

Optionally, when the reminder message display page is in a list form, the first display area is located at the top of the list, and the second display area is located below the first display area.

Optionally, the display mode is configured by a sender or a receiver of the reminder message.

Optionally, the apparatus for displaying reminder message 1600 may further includes the following module or unit stored in the memory 1604:

a display control unit 1620 configured to display details of the pin-to-top reminder message, and display thumbnails of the common reminder message.

Optionally, the reminder message is of a task type; and

the display control unit 1620 displays details of the pin-to-top reminder message by: displaying task information of the pin-to-top reminder message; and

the display control unit 1620 displays thumbnails of the common reminder message by: hiding task information of the common reminder message, wherein when the common reminder message is triggered, the task information of the common reminder message is displayed in a corresponding detail page.

Optionally, the display unit 1606 is specifically configured to:

when there is a plurality of pin-to-top reminder messages, arrange the plurality of pin-to-top reminder messages displayed at the top according to a corresponding receiving time sequence.

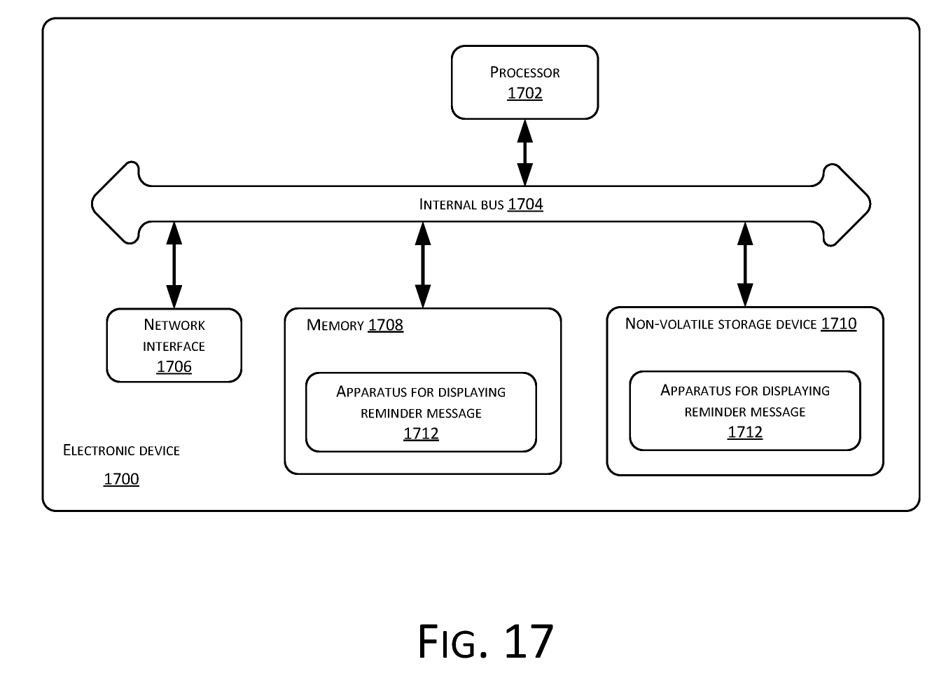

FIG. 17 is a schematic structural diagram of an electronic device 1700 according to an example embodiment of the present disclosure. Referring to FIG. 17, on the hardware level, the electronic device includes a processor 1702, an internal bus 1704, a network interface 1706, a memory 1708 and a non-volatile storage device 1710, and certainly may further include other hardware required by services. The processor 1702 reads a corresponding computer program from the non-volatile storage device 1710 to the memory 1702 and then runs the computer program to form an apparatus for displaying reminder message 1712 on the logic level. Certainly, in addition to software implementation manner, the present disclosure does not exclude other implementation manners, such as logic devices or a combination of software and hardware. In other words, the following processing procedure is executed by, but not limited to, various logic units, and may also be executed by hardware or logic devices.

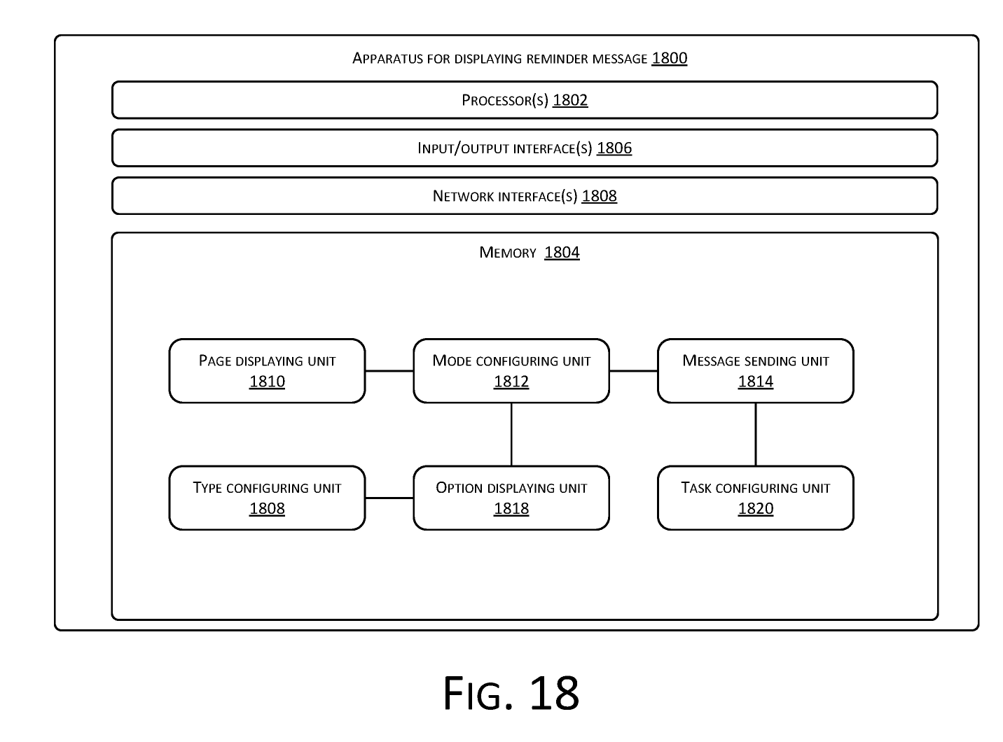

Referring to FIG. 18, an apparatus for displaying reminder message 1800 may include one or more processor(s) 1802 or data processing unit(s) and memory 1804. The apparatus for displaying reminder message 1800 may further include one or more input/output interface(s) 1806 and one or more network interface(s) 1808. The memory 1804 is an example of computer readable medium or media.

The memory 1804 may store therein a plurality of modules or units including a page displaying unit 1810, a mode configuring unit 1812, and a message sending unit 1814.

The page displaying unit 1810 is configured to display a reminder message creation page which comprises a mode switching identifier.

The mode configuring unit 1812 is configured to configure a reminder message generated in the reminder message creation page to be in a corresponding display mode according to a trigger operation for the mode switching identifier.

The message sending unit 1814 is configured to send the reminder message to a target object, wherein when the display mode is a pin-to-top mode, the reminder message is displayed in a first display area in a reminder message display page of the target object, while a reminder message in a common mode is displayed in a second display area in the reminder message display page, the second display area being different from the first display area.

Optionally, the apparatus for displaying reminder message 1800 may further includes the following modules or units stored in the memory 1804:

a type configuring unit 1816 configured to, when the reminder message creation page includes a task start identifier, configure the reminder message as a task type according to a trigger operation for the task start identifier;

an option displaying unit 1818 configured to display a pre-hidden task configuration option for the reminder message near the task start identifier; and

a task configuring unit 1820 configured to configure task information of the reminder message according to a received configuration operation for the task configuration option.

Optionally, the task information includes at least one of the following:

a deadline, and a task reminding moment before the deadline.

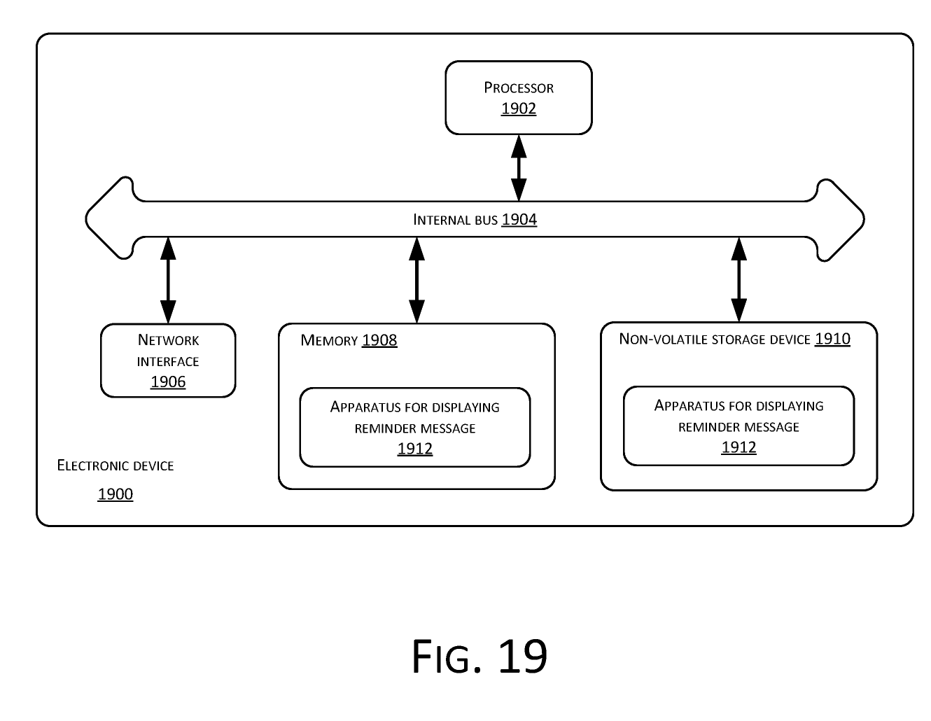

FIG. 19 is a schematic structural diagram of an electronic device 1900 according to an example embodiment of the present disclosure. Referring to FIG. 19, on the hardware level, the electronic device includes a processor 1902, an internal bus 1904, a network interface 1906, a memory 1908 and a non-volatile storage device 1910, and certainly may further include other hardware required by services. The processor 1902 reads a corresponding computer program from the non-volatile storage device 1910 to the memory 1902 and then runs the computer program to form an apparatus for displaying reminder message 1912 on the logic level. Certainly, in addition to software implementation manner, the present disclosure does not exclude other implementation manners, such as logic devices or a combination of software and hardware. In other words, the following processing procedure is executed by, but not limited to, various logic units, and may also be executed by hardware or logic devices.

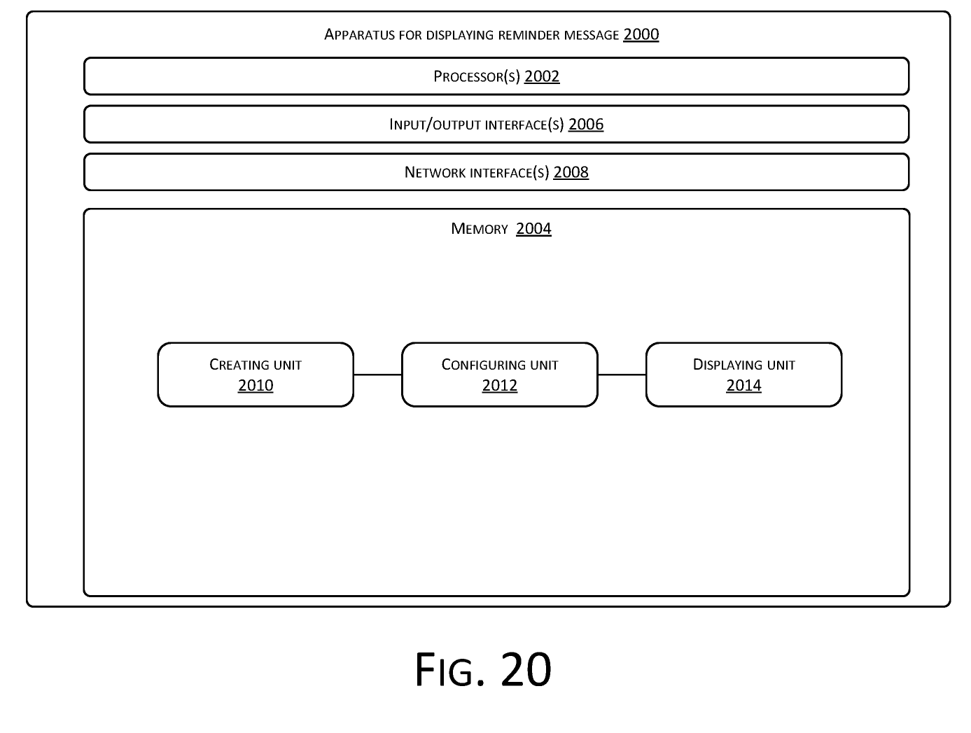

Referring to FIG. 20, an apparatus for displaying reminder message 2000 may include one or more processor(s) 2002 or data processing unit(s) and memory 2004. The apparatus for displaying reminder message 2000 may further include one or more input/output interface(s) 2006 and one or more network interface(s) 2008. The memory 2004 is an example of computer readable medium or media.

The memory 2004 may store therein a plurality of modules or units including a creating unit 2010, a configuring unit 2012, and a displaying unit 2014.

The creating unit 2010 is configured to create a reminder message.

The configuring unit 2012 is configured to configure a creator of the reminder message as a target object when an instruction for sending the reminder message is detected and no target object is configured for the reminder message.

The displaying unit 2014 is configured to receive and display the reminder message.

Optionally, the displaying unit 2014 is specifically configured to:

determine the reminder message as a pin-to-top reminder message or a common reminder message according to a display mode configured for the reminder message; and

display the pin-to-top reminder message in a first display area in a reminder message display page and display the common reminder message in a second display area in the reminder message display page, wherein the first display area and the second display area are respectively located at different positions in the reminder message display page.

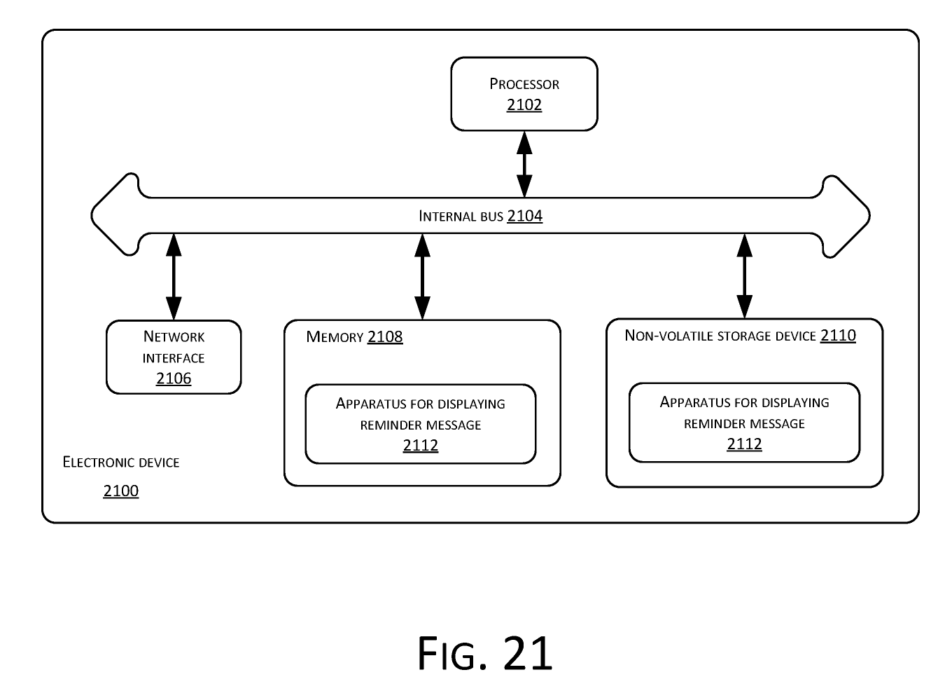

FIG. 21 is a schematic structural diagram of an electronic device according to an example embodiment of the present disclosure. Referring to FIG. 21, on the hardware level, the electronic device includes a processor 2102, an internal bus 2104, a network interface 2106, a memory 2108 and a non-volatile storage device 2110, and certainly may further include other hardware required by services. The processor 2102 reads a corresponding computer program from the non-volatile storage device 2110 to the memory 2102 and then runs the computer program to form an apparatus for displaying reminder message 2112 on the logic level. Certainly, in addition to software implementation manner, the present disclosure does not exclude other implementation manners, such as logic devices or a combination of software and hardware. In other words, the following processing procedure is executed by, but not limited to, various logic units, and may also be executed by hardware or logic devices.

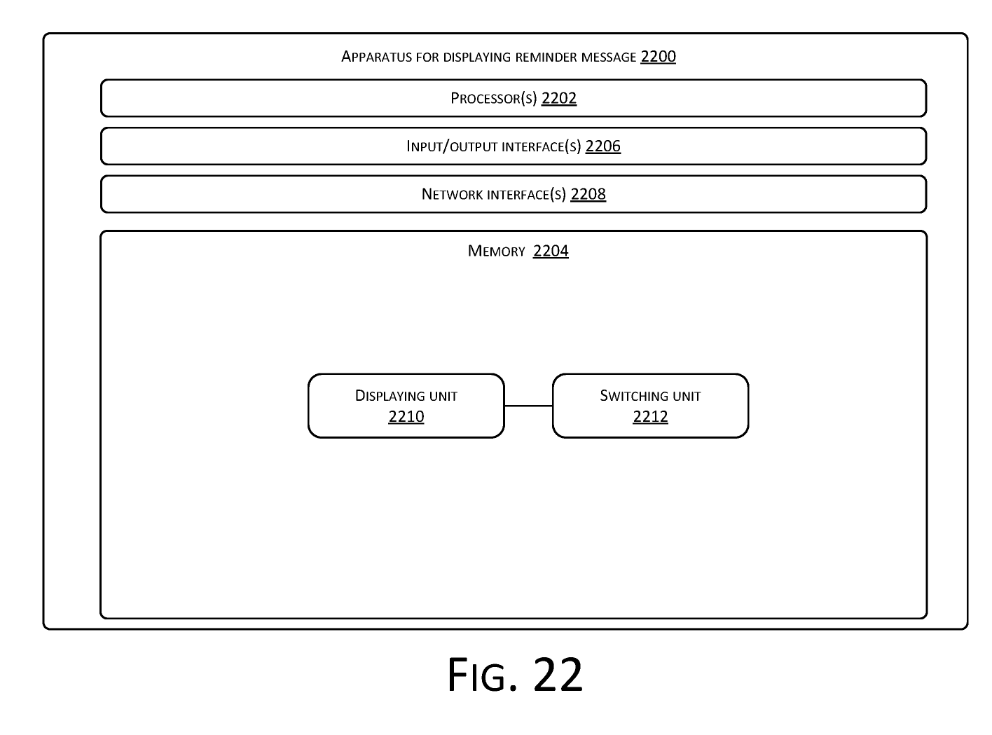

Referring to FIG. 22, the apparatus for displaying reminder message 2200 may include one or more processor(s) 2202 or data processing unit(s) and memory 2204. The apparatus for displaying reminder message 2200 may further include one or more input/output interface(s) 2206 and one or more network interface(s) 2208. The memory 2204 is an example of computer readable medium or media.

The memory 2204 may store therein a plurality of modules or units including a displaying unit 2210 and a switching unit 2212.

The displaying unit 2210 is configured to display a received reminder message, wherein a pin-to-top reminder message is displayed in a first display area in a reminder message display page, a common reminder message is displayed in a second display area in the reminder message display page, and the first display area and the second display area are respectively located at different positions in the reminder message display page.

The switching unit 2212 is configured to switch the common reminder message to a pin-to-top reminder message when the common reminder message is of a task type and a time interval to a deadline corresponding to the common reminder message is not greater than a preset time length.

In a typical configuration, a computing device includes one or more processors (CPU), an input/output interface, a network interface, and a memory.

The memory may include a volatile memory, a random-access memory (RAM) and/or a non-volatile storage device or the like in a computer readable medium, for example, a read-only memory (ROM) or a flash RAM. The memory is an example of the computer readable medium.

The computer readable medium includes non-volatile and volatile media as well as movable and non-movable media, and may store information by means of any method or technology. The information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

It should be further noted that the term “include”, “comprise” or other variations thereof are intended to cover non-exclusive inclusion, so that a process, method, commodity or device including a series of elements not only includes the elements, but also includes other elements not clearly listed, or further includes elements inherent to the process, method, commodity or device. In the absence of more limitations, an element defined by “including a/an . . . ” does not exclude that the process, method, commodity or device including the element further has other identical elements.

Example embodiments will be described in detail here, and examples thereof are shown in the accompanying drawings. In the following description involving the accompanying drawings, the same numerals in different accompanying drawings denote the same or similar elements, unless specified otherwise. Implementations described in the following example embodiments do not redisplay that all implementations are consistent with the present disclosure. In contrast, they are merely examples of apparatuses and methods consistent with some aspects of the present disclosure described in detail in the appended claims.

Terms used in the present disclosure are merely used for describing specific example embodiments, instead of limiting the present disclosure. Singular forms “a(n),” “said,” and “the” used in the present disclosure and the appended claims also include plural forms, unless clearly specified in the context that other meanings are denoted. It should be further understood that the term “and/or” used in this text refers to and includes any or all possible combinations of one or more associated items listed.

It should be understood that although terms such as “first,” “second,” and “third” may be used to describe various kinds of information in the present disclosure, these kinds of information should not limited to the terms. These terms are merely used to distinguish information of the same type from each other. For example, without departing from the scope of the present disclosure, the first information may also be referred to as second information, and similarly, the second information may also be referred to as first information. Depending on the context, the word “if” used herein may be explained as “when . . . ,” “as . . . ,” or “in response to the determination.”

The above description is merely preferred example embodiments of the present disclosure and is not intended to limit the present disclosure. Any modification, equivalent replacement and improvement made without departing from the spirit and principle of the present disclosure shall fall within the protection scope of the present disclosure.

The present disclosure may further be understood with clauses as follows.

Clause 1. A method for displaying a reminder message, the method comprising:

acquiring a received reminder message;

identifying a pin-to-top reminder message or a common reminder message from the reminder message according to a display mode configured for the reminder message; and

displaying the pin-to-top reminder message in a first display area in a reminder message display page, and displaying the common reminder message in a second display area in the reminder message display page, the first display area and the second display area being respectively located at different positions in the reminder message display page.

Clause 2. The method of clause 1, further comprising:

displaying a first identifier corresponding to the pin-to-top mode in a display range of the pin-to-top reminder message; and

displaying a second identifier corresponding to the common mode in a display range of the common reminder message, the first identifier being different from the second identifier.

Clause 3. The method of clause 2, wherein:

the first identifier comprises a pushpin icon in a pinned state; and

the second identifier comprises a pushpin icon in a non-pinned state.

Clause 4. The method of clause 2, further comprising:

switching the pin-to-top reminder message to the common reminder message according to a received trigger operation for the first identifier; and

switching the common reminder message to the pin-to-top reminder message according to a received trigger operation for the second identifier.

Clause 5. The method of clause 1, wherein when the reminder message display page is in a list form, the first display area is located at a top of the list, and the second display area is located below the first display area.

Clause 6. The method of clause 1, wherein the display mode is configured by a sender or a receiver of the reminder message.

Clause 7. The method of clause 1, further comprising:

displaying a detail of the pin-to-top reminder message; and

displaying a thumbnail of the common reminder message.

Clause 8. The method of clause 7, wherein

the reminder message is of a task type;

the displaying the detail of the pin-to-top reminder message comprises displaying task information of the pin-to-top reminder message; and

the displaying the thumbnail of the common reminder message comprises hiding the task information of the common reminder message, wherein when the common reminder message is triggered, the task information of the common reminder message is displayed in a corresponding detail page.

Clause 9. The method of clause 1, wherein the displaying the pin-to-top reminder message at the top position in a reminder message list page comprises:

when there is a plurality of pin-to-top reminder messages, arranging the plurality of pin-to-top reminder messages displayed according to a corresponding receiving time sequence.

Clause 10. A method for displaying a reminder message, the method comprising:

displaying a reminder message creation page that includes a mode switching identifier;

configuring a reminder message generated in the reminder message creation page to be in a corresponding display mode according to a trigger operation for the mode switching identifier; and

sending the reminder message to a target object,

wherein when the display mode is a pin-to-top mode, the reminder message is displayed in a first display area in a reminder message display page of the target object, while a reminder message in a common mode is displayed in a second display area in the reminder message display page, the second display area being different from the first display area.

Clause 11. The method of clause 10, further comprising:

when the reminder message creation page comprises a task start identifier, configuring the reminder message as a task type according to a trigger operation for the task start identifier; displaying a pre-hidden task configuration option for the reminder message near the task start identifier; and

configuring task information of the reminder message according to a received configuration operation for the task configuration option.

Clause 12. The method of clause 11, wherein the task information comprises at least one of the following:

a deadline; and

a task reminding moment before the deadline.

Clause 13. A method for displaying a reminder message, the method comprising:

creating a reminder message;

configuring a creator of the reminder message as a target object when an instruction for sending the reminder message is detected and no target object is configured for the reminder message; and

receiving and displaying the reminder message.

Clause 14. The method of clause 13, wherein the receiving and displaying the reminder message comprises:

determining the reminder message as a pin-to-top reminder message or a common reminder message according to a display mode configured for the reminder message; and

displaying the pin-to-top reminder message in a first display area in a reminder message display page, and displaying the common reminder message in a second display area in the reminder message display page, the first display area and the second display area being respectively located at different positions in the reminder message display page.

Clause 15. A method for displaying a reminder message, the method comprising:

displaying a received reminder message, wherein a pin-to-top reminder message is displayed in a first display area in a reminder message display page, a common reminder message is displayed in a second display area in the reminder message display page, and the first display area and the second display area are respectively located at different positions in the reminder message display page; and

switching the common reminder message to the pin-to-top reminder message when the common reminder message is of a task type and a time interval to a deadline corresponding to the common reminder message is not greater than a preset time length.

Clause 16. An apparatus for displaying a reminder message, the apparatus comprising:

an acquiring unit configured to acquire a received reminder message;

an identifying unit configured to identify a pin-to-top reminder message or a common reminder message from the reminder message according to a display mode configured for the reminder message; and

a displaying unit configured to display the pin-to-top reminder message in a first display area in a reminder message display page and display the common reminder message in a second display area in the reminder message display page, the first display area and the second display area being respectively located at different positions in the reminder message display page.

Clause 17. The apparatus of clause 16, further comprising:

an identifier displaying unit configured to display a first identifier corresponding to the pin-to-top mode in a display range of the pin-to-top reminder message and display a second identifier corresponding to the common mode in a display range of the common reminder message, the first identifier being different from the second identifier.

Clause 18. An apparatus for displaying a reminder message, the apparatus comprising:

a page displaying unit configured to display a reminder message creation page which comprises a mode switching identifier;

a mode configuring unit configured to configure a reminder message generated in the reminder message creation page to be in a corresponding display mode according to a trigger operation for the mode switching identifier; and

a message sending unit configured to send the reminder message to a target object, wherein when the display mode is a pin-to-top mode, the reminder message is displayed in a first display area in a reminder message display page of the target object, while a reminder message in a common mode is displayed in a second display area in the reminder message display page, the second display area being different from the first display area.

Clause 19. An apparatus for displaying a reminder message, the apparatus comprising:

a creating unit configured to create a reminder message;

a configuring unit configured to configure a creator of the reminder message as a target object when an instruction for sending the reminder message is detected and no target object is configured for the reminder message; and

a displaying unit configured to receive and display the reminder message.

Clause 20. An apparatus for displaying a reminder message, the apparatus comprising:

a displaying unit configured to display a received reminder message, wherein a pin-to-top reminder message is displayed in a first display area in a reminder message display page, a common reminder message is displayed in a second display area in the reminder message display page, and the first display area and the second display area are respectively located at different positions in the reminder message display page; and

a switching unit configured to switch the common reminder message to a pin-to-top reminder message when the common reminder message is of a task type and a time interval to a deadline corresponding to the common reminder message is not greater than a preset time length.

What is claimed is:

1. A method comprising:
acquiring a received reminder message;
identifying a prioritized reminder message or a common reminder message from the reminder message according to a display mode configured for the reminder message; and
displaying the prioritized reminder message in a first display area in a reminder message display page and the common reminder message in a second display area in the reminder message display page, the first display area and the second display area being respectively located at different positions in the reminder message display page.

2. The method of claim 1, further comprising:
displaying a first identifier corresponding to the pin-to-top mode in a display range of the prioritized reminder message; and
displaying a second identifier corresponding to the common mode in a display range of the common reminder message, the first identifier being different from the second identifier.

3. The method of claim 2, wherein:
the first identifier comprises a pushpin icon in a pinned state; and
the second identifier comprises a pushpin icon in a non-pinned state.

4. The method of claim 2, further comprising:
switching the prioritized reminder message to the common reminder message according to a received trigger operation for the first identifier.

5. The method of claim 2, further comprising:
switching the common reminder message to the prioritized reminder message according to a received trigger operation for the second identifier.

6. The method of claim 1, wherein when the reminder message display page is in a list form, the first display area is located at a top of the list, and the second display area is located below the first display area.

7. The method of claim 1, wherein the display mode is configured by a sender or a receiver of the reminder message.

8. The method of claim 1, further comprising displaying a detail of the prioritized reminder message.

9. The method of claim 8, wherein:
the reminder message is of a task type; and
the displaying the detail of the prioritized reminder message comprises displaying task information of the prioritized reminder message.

10. The method of claim 1, further comprising displaying a thumbnail of the common reminder message.

11. The method of claim 10, wherein:
the reminder message is of a task type; and
the displaying the thumbnail of the common reminder message comprises hiding the task information of the common reminder message.

12. The method of claim 11, further comprising:
determining that the common reminder message is triggered; and
displaying the task information of the common reminder message in a corresponding detail page.

13. The method of claim 1, wherein the displaying the prioritized reminder message in the first display area in the reminder message display page comprises

14. The method of claim 13, further comprising:
when there is a plurality of prioritized reminder messages, arranging the plurality of prioritized reminder messages displayed according to a corresponding receiving time sequence.

15. A method comprising:
displaying a reminder message creation page that includes a mode switching identifier;
configuring a reminder message generated in the reminder message creation page to be in a corresponding display mode according to a trigger operation for the mode switching identifier; and
sending the reminder message to a target object.

16. The method of claim 15, further comprising:
determining that the display mode is a pin-to-top mode; and
displaying the reminder message in a first display area in a reminder message display page of the target object.

17. The method of claim 16, further comprising:
determining that the display mode is a common mode; and
displaying the reminder message in a second display area in the reminder message display page, the second display area being different from the first display area.

18. The method of claim 15, further comprising:
when the reminder message creation page comprises a task start identifier, configuring the reminder message as a task type according to a trigger operation for the task start identifier;
displaying a pre-hidden task configuration option for the reminder message near the task start identifier; and
configuring task information of the reminder message according to a received configuration operation for the task configuration option.

19. The method of claim 18, wherein the task information comprises at least one of the following:
a deadline; and
a task reminding moment before the deadline.

20. A method comprising:
creating a reminder message;
configuring a creator of the reminder message as a target object when an instruction for sending the reminder message is detected and no target object is configured for the reminder message; and
receiving and displaying the reminder message.
